(19) United States
(12) Patent Application Publication
(10) Pub. No.: US 2006/0038769 A1
(43) Pub. Date: Feb. 23, 2006

(54) Display apparatus with scanning backlight

(75) Inventors: Johannes Marra, Eindhoven (NL); Dirk Jan Broer, Eindhoven (NL); Tijsbert Mathieu Henricus Creemers, Nijmegen (NL); Peter Alexander Duine, Eindhoven (NL); Hendrik De Koning, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/528,501

(22) PCT Filed: Aug. 8, 2003
(86) PCT No.: PCT/IB03/03558

§ 371 Date: Mar. 18, 2005

(30) Foreign Application Priority Data
Sep. 18, 2002 (EP) 02078862.6

(51) Int. Cl. G09G 3/36

(52) U.S. Cl. 345/102

(57) ABSTRACT

Display apparatus comprising an image-generating screen (46) repetitively scanned at a predetermined rate to display images, and a backlight for illuminating the screen. The backlight includes a light guide (10) arranged to constrain light by total internal reflection, the light guide having an output surface (22) with various locations from which light may be selectively coupled using a scanning arrangement (44). The scanning arrangement sequentially and repeatedly illuminates selected areas of said screen in synchronism with the repetitive scanning of the screen.

This invention relates to display apparatus including a display screen and a backlight for illuminating the display screen. It has special, though not exclusive, relevance to liquid crystal displays (LCDs) of the kind which are scanned to show moving images, and which may be incorporated in televisions, computer monitors and the like.

A known problem with such LCDs is that moving images tend to exhibit motion artefacts as a result of blurring caused by the fact that, because of the bistable nature of the LCD switching process, each pixel effectively remains frozen in its “on” or “off” condition throughout each screen refresh period. In the case of cathode ray tube (CRT) displays, this problem does not arise because each pixel only emits light for a very small fraction of each screen refresh period of about 15 to 20 ms, due to the natural decay characteristics associated with the fluorescence of the CRT's phosphor layer after excitation by the electron beam of the CRT.

Attempts have been made to sharpen LCD images by ensuring that each pixel is illuminated, and thus visually active, during only a small fraction (about 10%) of each refresh period. A scanning backlight is therefore used in which light sources in an array of light sources are rapidly and repeatedly switched on and off in synchronism with the image scan; thus effecting a directly-lit scanned illumination of the LCD screen in phase with the screen's refresh period. This solution is expensive to implement, since specialist light sources are required to cope with the rapid switching and cycling requirements. Moreover, since different individual light sources illuminate individual areas of the LCD screen, variations in the output of individual light sources show up as unwanted variations in the light intensity over the screen.

This invention aims to address the foregoing difficulties and drawbacks by providing a scanning backlight that is economical to produce and moreover does not involve direct backlighting of different areas of an LCD screen by respective light sources.

According to the present invention there is provided display apparatus comprising an image-generating screen repetitively scanned at a predetermined rate to display images, and a backlight for illuminating the screen, the backlight including:

at least one light source;

a light guide arranged to constrain light derived from said at least one source by total internal reflection, the light guide having an output surface with various locations from which light may be selectively coupled; and

scanning means configured to selectively couple light from said various locations on the output surface of said light guide to sequentially and repeatedly illuminate selected areas of said screen in synchronism with the repetitive scanning of said screen.

The invention thus provides the capability to emit light sequentially from selected locations of the light guide's output surface without the need for any corresponding switching of the at least one light source. Moreover, the light as emitted from each of said locations is substantially uniform, since it is derived from a generic source (i.e. the at least one source from which light is derived for propagation by TIR (total internal reflection) in the light guide) and the light is coupled out from the light guide under identical circumstances at each said location.

Preferably the screen comprises an LCD screen, though other forms of display may also benefit from the characteristics of the invention.

In one preferred embodiment, the light is selectively coupled out of the light guide at said selected locations by means of a flexible member, such as a polymeric light-scattering foil juxtaposed with the output surface of the light guide and capable of being attracted into local contact with said surface at each said location, thereby to locally disrupt the propagation by TIR of the light in the light guide and cause light emission from the selected locations. Preferably the movement of the foil relative to said output surface of the light guide is effected electrostatically under the influence of suitable dynamic voltage waveforms applied to suitably disposed transparent electrical contacts. The outcoupling arrangement so produced is similar in principle to prior art display arrangements, in which a mobile foil, disposed between a viewing screen and a backlight, is locally attracted, by the application of dynamic voltage waveforms, into contact with the output surface of the backlight at positions where (depending on the picture content to be displayed) light is to be emitted from the display. Examples of devices utilising a mobile foil and lighting arrangements therefor can be found in WO-A-9928890; WO-A-0038163; WO-A-0050949 and WO-A-0163588. It will be appreciated that, in the foregoing specifications, the mobile foil is used to provide directly the light output to be displayed, and not as a backlight for a principal display such as an LCD screen. In such prior art arrangements, the local points of contact between the foil and the backlight surface represent bright pixels in the output image.

In another preferred embodiment, the light may be selectively coupled out from said selected locations by means of a thin layer of a liquid crystal gel or a polymer dispersed liquid crystal incorporated into the light guide and disposed parallel to the output surface of the light guide.

In one embodiment, electrodes disposed on opposing surfaces and the apparatus is arranged to supply said electrodes with dynamic waveforms to selectively switch the scanning means between a substantially transparent non-scattering state and a scattering state. In a further embodiment the scanning means comprise electrodes disposed interdigitatedly on one surface and the apparatus is arranged to supply said electrodes with dynamic waveforms which form an electrical field to selectively switch the scanning means between a substantially transparent state and a scattering state.

Preferably, the light guide further comprises an input surface disposed to receive said light; said input surface including a plurality of spaced-apart incoupling elements upstanding therefrom and having respective sidewalls extending transversely of said input surface. More preferably, the backlight further includes reflective means disposed in spaces between said incoupling elements. The reflective means are preferably configured to reflect light into said light guide, only through the sidewalls of said incoupling elements, at angles such as to promote TIR of said light in said light guide.

In order that the invention may be clearly understood and readily carried into effect, certain embodiments thereof will now be described, by way of example only, with reference to the accompanying drawings, of which:

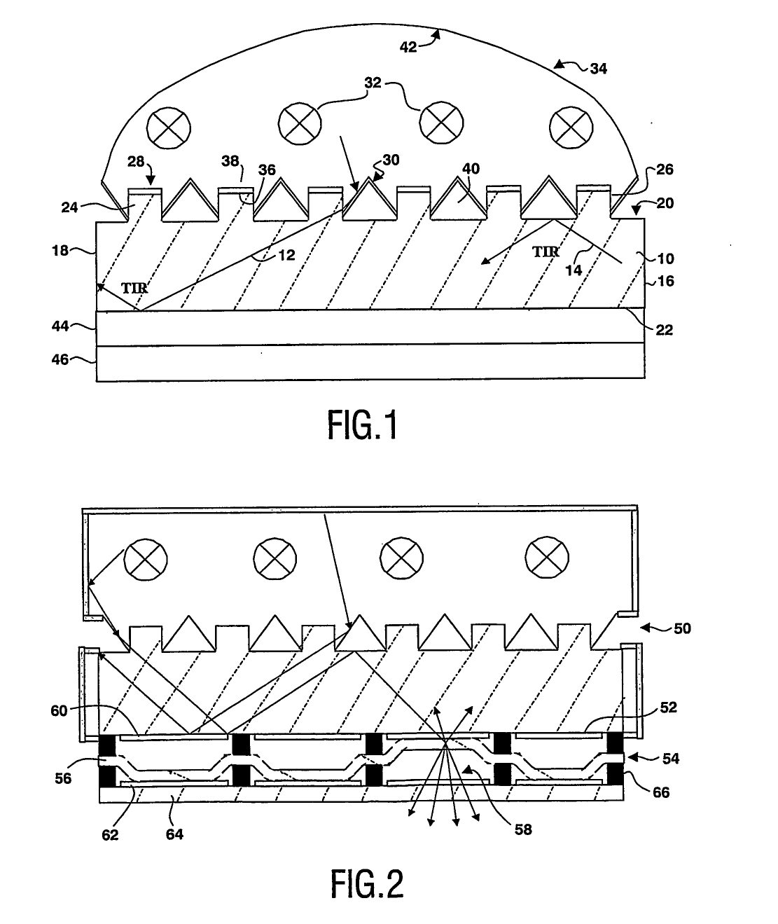

FIG. 1 shows, in schematic cross-sectional view, a general construction of a display in accordance with various different embodiments of the invention;

FIG. 2 shows, in schematic cross-sectional view, a scanning backlight arrangement according to one embodiment of this invention for use in the arrangement of FIG. 1;

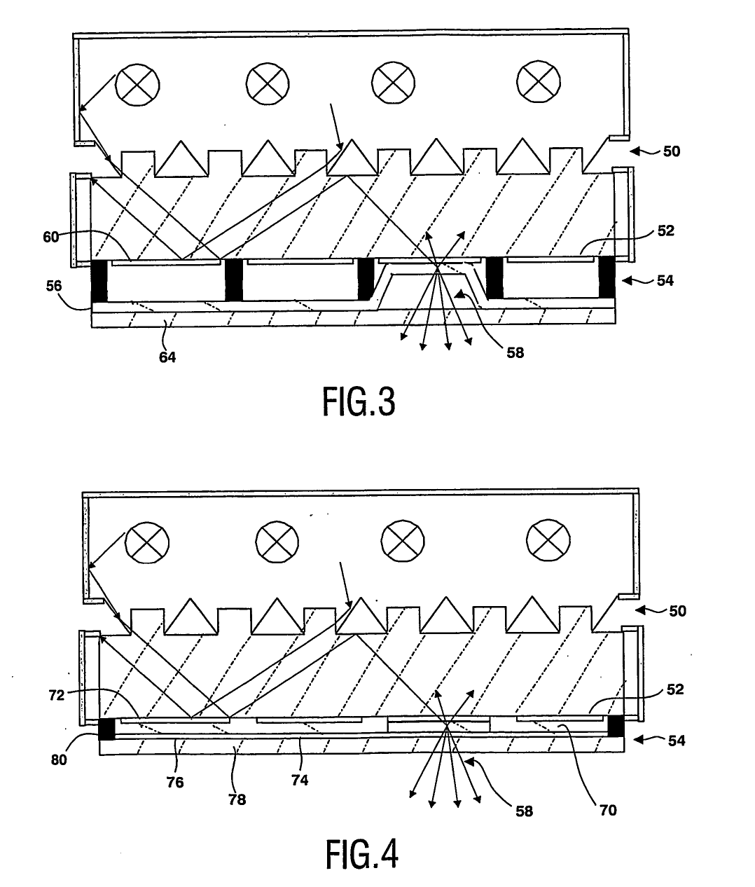

FIG. 3 shows, in schematic cross-sectional view, a scanning backlight arrangement according to a further embodiment of this invention for use in the arrangement of FIG. 1; and

FIG. 4 shows, in schematic cross-sectional view, a scanning backlight arrangement according to a further embodiment of this invention for use in the arrangement of FIG. 1.

Referring now to FIG. 1, there is shown a display including a backlight comprising a light guide 10, a light box 34, a backlight scanning element 44, supplying light scanningwise to a flat panel display screen 46. The display screen 46, preferably an LCD screen, includes a matrix of electrodes whereby transmitted light intensities on pixel-sized areas are modulated for generating image frames by means of image scanning circuitry (not shown) in accordance with a received image signal. The display screen 46 may be of a monochrome or colour type transmissive display screen. The scanning of the backlight is synchronised with the scanning of the display screen using synchronising circuitry (not shown) receiving scanning signals derived from the image signal source and outputting backlight scanning timing signals.

Light is intended to propagate within the light guide 10 by TIR, as indicated schematically by the arrowed lines 12 and 14. The light guide 10 is, in this embodiment, thin and plate-like in construction, formed from a solid transparent material such as glass or a plastics material. The light guide 10 has edges 16, 18 of relatively small dimensions, whilst its upper and lower surfaces 20 and 22 respectively, as seen in the drawing, are generally rectangular and of relatively large dimensions, commensurate with a display area.

The lower surface 22 of the light guide 10, as viewed in the drawing, is substantially planar and constitutes in this example the output surface of the light guide.

The upper surface 20, as viewed in the drawing, constitutes the light input surface and includes a one-dimensional array of spaced apart, upstanding incoupling elements 24. In this example, each incoupling element 24 consists of an elongate ridge of substantially rectangular cross-section formed as part of, and disposed transversely across, the surface 20. The elements 24 each have sidewalls 26 and an outer surface 28; the sidewalls being, in this embodiment, upright and substantially orthogonal to the input surface 20 of the light guide 10 though this need not necessarily be the case.

In the spaces between the incoupling elements 24 are provided reflective elements 30, which inhibit light entering the light guide through the input surface in the spaces, at angles which would not promote TIR in the light guide 10. The reflective elements 30 in this example comprise laminar members formed into inverted V-shapes, effectively extending from the base of the sidewall 26 of one incoupling element 24 to the base of the sidewall 26 of an adjacent incoupling element 24. The reflective elements 30 are arranged such that substantially no optical coupling exists between the reflective elements 30 and the input surface 20 of the light guide 10 in order to reduce unwanted outcoupling of light propagating by TIR in the light guide 10.

An array of light sources such as tubular fluorescent lamps 32 is disposed in a lightbox 34 and closely coupled to the input surface 20 of the light guide 10.

The incoupling elements 24 may be configured in various different formats and, instead of being formed as a one-dimensional array of elongate ridges of rectangular profile, may alternatively be formed, for example, as a two-dimensional array of upstanding post-like elements such as cubes or cylinders. In any event, however, the sidewalls 26 are configured to provide the sole access for light from the lightbox 34 into the light guide 10, and vice-versa. The endwalls 28 of the incoupling elements are first provided with a light-absorbing coating layer such as a black layer 36, and on top of that are provided with a reflective coating 38 which is preferably a white diffuse reflective coating. The purpose of the coating 36 is to absorb any stray light incident from within the light guide 10 that strikes the outer surface 28 since such light, if it were allowed to continue by back-reflection from the outer surface 28, would not be subject to TIR and thus might emerge as unwanted stray light from an endwall 22. The reflective coating 38 inhibits light incident from the light box 34 from entering the light guide at angles which would not promote TIR in the light guide, and redirects such incident light back into the light box 34.

Likewise, the reflective elements 30 are provided with a reflective coating, preferably a white diffuse reflective coating on the surface which faces the lamps and with a black absorbent coating on its surface which faces the light guide 10. Moreover, air is disposed in the area 40 between the reflective elements and the light guide to reduce the extent of optical coupling between the reflective elements and the light guide and thus the outcoupling of useful light that is propagating in the light guide under TIR conditions.

The lightbox 34 is coated with diffusive white reflective material on its internal surface 42, so as to maximise the amount of light from the lamps that is constrained within, and thus usable by the system.

Instead of, or in addition to, the array of tubular fluorescent lamps 32, other light sources such as LEDs may be employed within the lightbox 34.

Where tubular fluorescent lamps are used, their axes preferably run parallel to the surface 20 and to the long axes of the incoupling elements 24, where these are elongate in form. There is no direct correlation between the number of light sources employed and either the number of incoupling elements provided or the dimensions of the light guide; the various values and dimensions can be arranged to suit the operating requirements of the system as a whole.

The reflective elements 30 need not provide tilted reflective surfaces as shown in the drawing and can take any convenient and practical form, bearing in mind their intended use to divert light into the light guide 10 through the sidewalls 26 of the incoupling members 24 and the requirements that substantially no optical coupling should exist between the reflective elements 30 and the input surface 20 of the light guide. The sidewalls are preferably substantially orthogonal to the input surface 20 though, as previously mentioned, this is not essential and they may be disposed at other orientations.

In the following drawings, a backlight of the general form described above is illustrated schematically and in a somewhat simplified form as a dual block 50, with the output surface of the light guide being represented at 52. For illustration purposes the display screen 46 is omitted, but should be understood to be present.

With regard to the embodiments of the invention now to be described by way of example, it will be appreciated that, in each case, the scanning backlight is not intended to couple light from respective backlighting areas on the output surface 52 in a one-to-one relationship with respective pixels of the display. Rather, the intention is for each of the backlighting areas on the output surface to span a plurality of pixels disposed, for example, in a square or strip-like formation.

Referring now to FIG. 2, a first embodiment of the invention comprises a backlight 50, with an output surface 52 as described above, and a scanning mechanism 54 to permit the selective emission of light from various locations on the output surface 52.

In this example, the scanning mechanism 54 comprises a polymeric foil 56 containing scattering particles which is capable of selectively being brought into contact with various locations on the output surface 52 of the backlight 50 to couple light out of the light guide at those locations and to scatter the light so outcoupled substantially isotropically, as indicated at 58, towards the display screen (not shown).

In the embodiment of FIG. 2, transparent row electrodes 60 are provided on the output surface 52 and transparent column electrodes 62 are provided on the inner surface of a transparent support plate member 64; a common electrode (not shown) being provided on the side of the foil 56 which faces the column electrodes.

The foil is supported by spacers such as 66 in juxtaposed relationship with the output surface 52; and the arrangement in general may be produced in accordance with manufacturing procedures developed for the foil display and as described, for example, in the aforementioned international patent applications.

The selective bending of the foil 56 towards the output surface 52 of the backlight 50 is controlled by means of the application of dynamic voltage waveforms to the various electrodes, to achieve a scanned illumination of parts of the LCD screen with scattered light 58 by selectively causing the foil 56 to sequentially contact the output surface 52 at different locations, thereby establishing scanned contact between the foil and the light guide across respective locations corresponding to substantially rectangular backlighting areas, each of which occupies between 2% and 20%, preferably about 10%, of the total surface area of the LCD screen.

The embodiment of the invention shown in FIG. 3 is similar to that of FIG. 2, except that no column electrodes are provided on the support plate 64, so that the backlighting areas on the output surface 52 from which light emission occurs in response to scanned contact with the foil 56 comprise respective strips, rather than rectangular areas. Each strip, however, illuminates between 2% and 20%, preferably about 10%, of the LCD screen towards which the scattered light 58 is directed.

It will be appreciated that the electrodes 60 should possess substantially optically smooth surfaces in order to avoid unwanted disturbance of TIR.

In the embodiment of the invention shown in FIG. 4, a layer 70 of a liquid crystalline gel is provided on the output surface 52 of the backlight 50.

Row electrodes 72 and a common electrode 74 are disposed to opposing sides of the layer 70, these electrodes being provided respectively on the output surface 52 and the inner surface 76 of a transparent plate member 78; the latter being juxtaposed with the output surface 52 and separated therefrom by means of spacers 80.

The liquid crystal gel of the layer 70 is normally non-scattering and thus does not disturb light propagating under TIR conditions in the light guide of the backlight 50. Indeed, the layer 70 and the plate member 78 can be considered as constituting part of the light guide providing their refractive indices are selected appropriately.

The transparent electrodes 72, 74 are preferably formed of indium tin oxide (ITO) and advantageously may be coated with a polyimide orientation layer such as Nissan Chemical Polyimide SE7511L. The liquid crystal gel material forming the layer 70 is prepared, in this example, from a mixture of a nematic liquid crystal, a liquid crystal diacrylate monomer and a photoinitiator in the ratio 92.00:7.95:0.05 by weight; the nematic liquid crystal mixture being chosen to exhibit negative dielectric anisotropy. This latter characteristic ensures that the liquid crystal switches with the molecular director (the average direction of the molecular long axes of the rod-like liquid crystal molecules).

In the field-off state, the polyimide orientation layer orients the aforementioned long axes of the liquid crystal mixture into alignment, generally across the thin dimension of the gel layer 70 in this condition, the liquid crystal monomer is polymerised by controlled exposure to UV light. The polymer network that is formed has an open structure consisting of cells filled with the non-reactive nematic liquid crystal and cell walls that consist of a densely crosslinked diacrylate that is oriented with its long molecular axis parallel to the orientation of the nematic liquid crystal. The refractive indices of the phase separated polymer network and the nematic liquid crystal are matched, which means that, in the field-off state, the layer 70 is transparent and the layer 70 exerts substantially no influence upon light propagating in the backlight 50.

When, however, a field is applied across the electrodes disposed to either side of the gel layer 70 at a chosen location relative to the output surface 52 of the backlight 50, the liquid crystal material orients perpendicular to the field lines. Because of the presence of the polymer network, the orientation is random and micrometer sized domains are formed that scatter the light at the selected locations. This scattering is sufficient, as indicated at 58, to couple light out of the surface 52 into the general direction of the LCD screen (not shown) and ultimately to a viewer of the display. In this embodiment, the backlighting areas are in the form of a one-dimensional array or strip, each strip illuminating between 2% and 20%, preferably about 10%, of the LCD screen towards which the scattered light 58 is directed.

In yet another embodiment, the light may be selectively coupled out from said selected locations by means of a thin layer of a polymer dispersed liquid crystal (PDLC) incorporated into the light guide and disposed parallel to the output surface of the light guide. PDLC layers are known to those skilled in the field of liquid crystal based electro-optical switches and are for instance formed from a blend of liquid crystal and at least one monomer. The monomer can polymerised into a polymer by heat or by actinic irradiation where phase separation of the formed polymer gives rise to a scattering state. When addressed with an electrical field the refractive indices of the polymer are matched to that of the liquid crystals which makes them transparent for the transmitting light. In this embodiment, electrodes disposed on opposing surfaces of the PDLC layer are supplied with dynamic waveforms to selectively switch the layer between a transparent (non-scattering) state and a scattering state, depending on the need for light emission at the various locations. The matching of the refractive indices in this case should be such that they are equal for the light that is impinging on the layer in the light guide. This is opposite to most current PDLC applications where the light transmits perpendicular to the plane of the film.

It will be appreciated that further alternative scattering mechanisms can be used to achieve one or more of the objectives of the invention without departing from the scope of the present invention. For example, in the FIG. 4 embodiment, polymer dispersed liquid crystals or polymer filled nematics may be used, though the formation of a polymer network in a liquid crystal are much preferred. Also it will be appreciated that other electrode configurations are possible. In another preferred embodiment the two electrodes are not placed opposite to each other with respect to the liquid crystal containing film but at the same side for instance in an interdigitated way. When a voltage is applied on two electrodes next to each other an electrical field in the plane of the field switches the liquid crystal containing film from a non-scattering state to a scattering state or visa versa. In the case of the liquid crystal gel vertically aligned liquid crystals with a positive dielectric anisotropy can be utilised which, together with the fact that only one substrate needs to be provided with electrodes, leads to especially cost-effective devices.

Moreover, different backlighting arrangements to that shown in and described with reference to FIG. 1 may be used, though it is preferred that a backlight capable of supplying a substantially uniform illumination irrespective of location relative to the display screen is used, and it is also preferred that the light source, or light sources, incorporated in the backlight can be run continuously whilst the display is in use.

If desired, a further screen, such as a lenticular, diffracting or purely diffusing screen, may be inserted between the scanning backlight and the screen which it is intended to illuminate. By this means, the edges of the illuminated regions can be defocused or de-emphasised, thereby reducing any risk that unwanted artefacts might be generated in response to sharply defined edges to sequentially illuminated regions.

The invention encompasses display apparatus such as broadcast/cable TV receivers, specialist monitoring equipment, for medical, technical or forensic purposes for example, and monitors for personal computers.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. Display apparatus comprising an image-generating screen repetitively scanned at a predetermined rate to display images, and a backlight for illuminating the screen, the backlight including:
at least one light source;
a light guide arranged to constrain light derived from said at least one source by total internal reflection, the light guide having an output surface with various locations from which light may be selectively coupled; and
scanning means configured to selectively couple light from said various locations on the output surface of said light guide to sequentially and repeatedly illuminate selected areas of said screen in synchronism with the repetitive scanning of said screen.

2. Display apparatus according to claim 1, configured to couple light sequentially from said various locations during continuous activation of the at least one light source.

3. Display apparatus according to claim 1, wherein the screen comprises a liquid crystal display screen.

4. Display apparatus according to claim 1, wherein the scanning means comprise a flexible member juxtaposed with the output surface of the light guide, capable of being selectively attracted into local contact with said surface.

5. Display apparatus according to claim 4, wherein said flexible member comprises a polymeric light-scattering foil.

6. Display apparatus according to claim 4, wherein the scanning means comprise transparent electrical contacts and the flexible member is arranged to be moved relative to the output surface of the light guide electrostatically under the influence of dynamic voltage waveforms applied to said contacts.

7. Display apparatus according to claim 1, wherein the scanning means comprise a thin layer of a liquid crystal gel disposed substantially parallel to the output surface of the light guide.

8. Display apparatus according to claim 7, wherein said liquid crystal gel is prepared from a mixture of a nematic liquid crystal, a liquid crystal diacrylate monomer and a photoinitiator.

9. Display apparatus according to claim 8, wherein the nematic liquid crystal mixture exhibits negative dielectric anisotropy.

10. Display apparatus according to claim 1, wherein the scanning means comprise a thin layer of a polymer dispersed liquid crystal disposed substantially parallel to the output surface of the light guide.

11. Display apparatus according to claim 7, wherein the scanning means comprise electrodes disposed on opposing surfaces and the apparatus is arranged to supply said electrodes with dynamic waveforms to selectively switch the scanning means between a substantially transparent non-scattering state and a scattering state.

12. Display apparatus according to claim 7, wherein the scanning means comprise electrodes disposed interdigitatedly on one surface and the apparatus is arranged to supply said electrodes with dynamic waveforms which form an electrical field to selectively switch the scanning means between a substantially transparent state and a scattering state.

13. Display apparatus according to claim 1, wherein each of said various locations forms part of a different elongate backlighting area, said backlighting areas being arranged in a one dimensional array.

14. Display apparatus according to claim 1, wherein each of said various locations forms part of a different substantially rectangular backlighting area, said backlighting areas being arranged in a two dimensional array.

15. Display apparatus according to claim 13, each said backlighting area corresponding to 20% or less of the total surface area of the said screen.

16. Display apparatus according to claim 13, each said backlighting area corresponding to 2% or more of the total surface area of the said screen.

17. Display apparatus according to claim 13, wherein each said backlighting area corresponds in size to a plurality of pixels on said screen.

18. Display apparatus according to claim 1, wherein said light guide further comprises an input surface disposed to receive said light, the input surface including a plurality of spaced-apart incoupling elements having respective sidewalls extending transversely of said input surface.

19. Display apparatus according to claim 18, the backlight further comprising reflective means disposed in spaces between said incoupling elements.
